(19) United States
(12) Patent Application Publication
(10) Pub. No.: US 2018/0018647 A1
(43) Pub. Date: Jan. 18, 2018

(54) Method and system for managing consumer-directed accounts

(71) Applicant: JPMorgan Chase Bank, N.A., New York, NY (US)

(72) Inventors: Marc Lawrence FREDMAN, Chicago, IL (US); John Michael Prince, Chicago, IL (US); Kathleen Nugent, Evanston, IL (US); Hannah Hayes Dillon, Oak Lawn, IL (US); Mark Pratt, Chicago, IL (US); David Adam Josephs, Deer Park, IL (US)

(21) Appl. No.: 14/502,480

(22) Filed: Sep. 30, 2014

Related U.S. Application Data
(63) Continuation of application No. 10/413,376, filed on Apr. 15, 2003, now abandoned.

(51) Int. Cl. G06Q 20/14; G06Q 50/22

(52) U.S. Cl. CPC G06Q 20/14; G06Q 50/22

(57) ABSTRACT

According to one embodiment, the present invention relates to a method and a system for substantiating claims prior to payment from consumer-directed accounts. A computer implemented method for providing consumer-directed account management comprising the steps of receiving a request for payment for a transaction wherein the request comprises claim data identifying the transaction and a payment amount; adjudicating the request to determine claim eligibility; requesting a validation of available funds in a consumer-directed account associated with a participant for the payment amount, wherein a party contributes a predetermined amount of funds to the consumer-directed account; receiving a confirmation indicating whether the consumer-directed account contains sufficient funds to cover the payment amount; and transmitting a validation message indicating payment validation and claim eligibility.

### FIELD OF THE INVENTION

The present invention relates generally to managing consumer-directed accounts and, more particularly, to a method and system for electronically substantiating claims prior to making payments from consumer-directed accounts (e.g., Flexible Spending Accounts, Medical Savings Accounts, Health Reimbursement Arrangements, etc.) and facilitating settlement and messaging throughout a transaction cycle.

### BACKGROUND OF THE INVENTION

As healthcare expenses continue to rise, consumers are taking on a bigger role in paying and managing healthcare costs. This increase in consumer responsibility ranges from greater cost-sharing for medical services to having to choose among increasing healthcare financing options. One important tool for consumer participation in healthcare is the use of consumer-directed accounts. Consumer-directed accounts are dedicated funding pools used for healthcare expenses at the discretion of an individual. These accounts can be procured either individually or through an employer, and may or may not involve tax advantages to the user of the account. A key requirement in the use of consumer-directed accounts is that they finance only those goods and services that are authorized by the Internal Revenue Service (IRS) as eligible medical expenses. This creates the need for close oversight of consumer-directed account programs, which involves high paper volumes, manual intervention, and substantial administrative expense to ensure compliance. In addition, the current process often requires participants to pay for goods and services and then file for reimbursement out of the funds contributed to the consumer-directed account, instead of paying for goods and services from the account directly. This requires participants to make the payment up-front even though the funds may have already been set aside and to handle a variety of paper documents during filing and reimbursement. These challenges significantly undermine the efficiency of consumer-directed account programs, resulting in dissatisfied participants and program sponsors. Given these difficulties, there is a clear need for an electronic solution that automates the administration and use of consumer-directed accounts, while maintaining compliance with the rules and regulations under which consumer-directed accounts are governed.

The trend to consumer-directed healthcare has been supported by three major legislative innovations within the past thirty years; namely, the Revenue Act of 1978, the Health Insurance Portability and Accountability Act of 1996 (HIPAA) and a ruling in 2002 by the IRS establishing Health Reimbursement Arrangements. Each of these initiatives created the model for a consumer-directed account in use today. The Revenue Act of 1978 created Flexible Spending Accounts (FSA), which are employer-sponsored accounts funded by employees' pre-tax contributions from payroll. Flexible Spending Accounts can be established and used for a variety of purposes, such as the payment of healthcare, dependent care, or public transportation expenses. Because Flexible Spending Accounts are funded with pre-tax dollars, participants in an FSA program can realize substantial savings on eligible expenses. Employers value FSA programs because these accounts provide benefits to employees and reduce employees' taxable income on which an employer must pay Federal. Insurance Contributions Act (FICA) taxes. Currently, there are more than 8 million Health Flexible Spending Accounts in the US, with over 9 billion dollars in annual contributions. Health FSA contributions are expected to grow significantly over the next several years, as consumers take on more of the burden for healthcare costs and seek tax-advantaged tools to finance those expenses.

Two other types of consumer-directed accounts—the Medical Savings Account (MSA) and the Health Reimbursement Arrangement (HRA)—were introduced within the past decade. The MSA was established with the passage of HIPAA in 1996. The MSA provides for a tax-advantaged account reserved for individuals who are self-employed or employed at a small business, and who use a qualifying high-deductible health plan. The MSA is designed to provide tax benefits on payments towards a deductible portion of a high-deductible health plan. A key advantage of the MSA to participants is the ability to carry over unused funds in the account from one plan year to the next. This differs from FSA programs that require unused funds to be forfeited by the employee and turned over to the employer health plan, a requirement commonly known as the FSA “use it or lose it” provision. The IRS established the HRA in June 2002, drawing on the strengths of both the FSA and the MSA. For example, employers of all sizes may implement an HRA program (e.g., FSA). In addition, unused funds contributed to an HRA may roll over from one plan year to the next, like MSA. Due to its flexibility and attractiveness to employees, the HRA is expected to quickly become prevalent throughout the employee benefits marketplace.

A result of these initiatives is the proliferation of consumer-directed accounts used to provide tax advantages for healthcare spending. Although FSA, MSA, and HRA are the most common forms of consumer-directed accounts, others may also exist. As consumer-directed healthcare evolves, there will be continued innovation in the field of consumer-directed accounts. This will likely result in new account structures being introduced over time.

Because consumer-directed accounts are legal structures, there are a wide variety of associated rules and regulations. Some important rules include provisions on the types of expenses that can be financed through a consumer-directed account, as determined by the IRS. In general, consumer-directed accounts can only pay for expenses that are medically necessary (such as prescription eye care, prescription drugs, hearing devices, or any other medically necessary expenses), whereas expenses that are not medically necessary (typically “cosmetic” goods and services such as non-prescription sunglasses, cosmetic surgery, or any other non-medically necessary expenses) are deemed ineligible. Because consumer-directed accounts confer tax advantages to participants, the IRS requires strict compliance from employers and their agents to ensure that only eligible medical expenses are financed through a consumer-directed account. If ineligible medical expenses are paid for through a consumer-directed account, tax advantages are being made available inappropriately. As a result, the IRS can assign and enforce penalties for non-compliance.

Most consumer-directed accounts offered through an employer benefits plan are managed and administered by an entity other than the employer itself, usually a Third Party Administrator (TPA). A TPA can provide a variety of services to employers, such as managing claim submissions from employees and generating reports on plan usage. The requirements to comply with IRS guidelines for expense eligibility create a heavy burden on the TPA in managing a consumer-directed account program. Whenever an employee files for reimbursement out of a consumer-directed account, the TPA must audit and validate the claim to ensure that it is for a valid medical expense. Typically, the employee will provide proof of eligibility in the form of a paper receipt or invoice documenting the nature of the expense, which the TPA reviews to confirm compliance. This validation process is extremely labor-intensive and generally requires TPA personnel to review a given claim manually. Further complicating the TPA's task of ensuring compliance is the ability of employers to customize expense eligibility rules to their particular program. That is, although the IRS governs what is potentially allowed, employers have the option to limit further the specific types of expenses that their particular consumer-directed account program will authorize. A TPA must therefore consult the plan rules for a given program before granting approval to an employee's claim. After the claim has been deemed eligible and sufficient funds have been confirmed within the employee's consumer-directed account, the TPA will remit funds, usually by paper check, with a paper explanation of payment to the employee.

Because of the challenges associated with the current manual processing and administration of consumer-directed accounts, industry participants have attempted to develop a variety of mechanisms to streamline activities and improve automation. As consumer-directed accounts grow in importance and usage, these efforts will become increasingly relevant to the ways in which healthcare expenses are paid and managed.

Efforts to innovate within the administration and use of consumer-directed accounts have historically proceeded in two key ways. First, many Third Party Administrators have attempted to manage the existing paper process better without actually reducing the submissions of paper claim forms. An example of this type of innovation is the use of scanning and character-recognition technology to store an electronic copy of paper claims as they are received and to adjudicate claims based on the information contained in the electronic image. Using this type of technology reduces the amount of paper that a TPA has to keep on file and enables better management of claim documents than if such documents were to remain in paper form. Although this approach may realize certain cost savings, the key problems associated with the current process for managing consumer-directed accounts still remain. That is, participants still have to prepare and file paper claims and front payment for goods and services, and Third Party Administrators must still handle paper documents and manually review the expense eligibility of submitted claims.

The second way industry participants have sought to improve the administration and use of consumer-directed accounts is to attempt to reduce the number of paper claim forms submitted by participants. Manual mechanisms for obviating claim form submission have existed for several years. For example, in some cases, a TPA may be able to make a direct payment from a consumer-directed account to a provider of eligible goods or services without the participant having to file a claim form or initiate a payment. This method is usually applied for payments that are recurring in nature (such as elder care or regular prescription drug purchases), because it requires notifying the provider to change their process and forward an invoice for payment to the TPA directly rather than to the employee. In addition, such payments are only possible when payment is not required at the time services are rendered. For prescription drug transactions within a pharmacy, for example, payment is expected at the point of sale, precluding a post-hoc payment from the TPA to the provider. Moreover, although the participant does not have to file a paper claim form, the TPA must still employ a manual process for adjudicating and paying claims.

Another manual mechanism for reducing the number of paper claim submissions by savings account participants is to automatically apply consumer-directed account funds towards deductibles or co-payments determined under an employer-sponsored health plan. This option has historically been possible only when the TPA manages claims for both the consumer-directed account and the health plan for a given employer. In this scenario, an employee obtains goods or services from a medical provider, causing the provider to generate and submit a claim to the employee's health plan. Once the TPA has adjudicated the claim and determined the employee's payment responsibility, the TPA remits funds from the consumer-directed account directly to the provider, eliminating the need for the employee to pay the provider up-front and then prepare and file a claim with the TPA for reimbursement from the consumer-directed account. However, instances when an individual TPA manages both the consumer-directed accounts and the health plan for a given employer are limited, making this option available to relatively few consumer-directed account participants.

An alternative mechanism for reducing paper claims submissions and improving efficiencies involves enabling electronic claim submission and payment through the use of a stored value program. A stored value program typically includes supplying each participant with a payment card that is linked to a consumer-directed account. A participant then presents the physical card or the card number for payment wherever medical expenses are incurred. The healthcare provider initiates a payment transaction, that transfers funds from the consumer-directed account to the provider's bank account, eliminating the need for the participant to provide up-front payment and then file for later reimbursement through the TPA. Likewise, the TPA benefits by not having to manage and process paper forms and claims associated with the card-initiated transaction. Because of the wide acceptance of payment cards, participants are able to use consumer-directed account funds in a variety of venues, such as in a retail location, through the mail, or over the phone and other types of transactions.

Although stored value programs have the potential to create substantial efficiencies and benefits, they also have the potential for substantial abuse. In particular, current programs risk exposing employers and Third Party Administrators to non-compliance with IRS guidelines for consumer-directed account expense eligibility. Unlike the current manual process that allows a TPA to audit detailed transaction information in the form of a submitted receipt, card transactions generally communicate only the payment amount requested and the type of merchant that is initiating the transaction (e.g., a pharmacy, a toy store, etc.). Many stored value programs thus authorize the use of card payments to merchants that are considered “healthcare providers” (such as doctors, optometrists, pharmacies, etc.) and deny card transactions at non-healthcare merchants (such as a toy store or apparel retailer). This type of filtering is inadequate because many putative healthcare merchants may still sell goods or services that do not meet the IRS guidelines for payment from a consumer-directed account. For example, a consumer-directed account participant receiving services from a physician's office may be receiving cosmetic enhancements that are not medically necessary. Alternatively, a participant may present their card at a pharmacy for payment toward a wide variety of non-eligible goods (e.g., magazines, office supplies, etc.). Unless a stored value program analyzes detailed, individual transaction data to determine expense eligibility, ineligible expenses may be inappropriately authorized and funded by the consumer-directed account.

Because of the risk of non-compliance associated with card programs, many Third Party Administrators review card transactions post-payment and audit them for inappropriate activity. According to IRS guidelines, claims do not need to be confirmed as eligible expenses prior to payment as long as 100% of all claims are reviewed post-payment. In cases where expenses paid by a consumer-directed account are later deemed ineligible, participants must be made to restore misappropriated funds to the savings account, forcing the TPA into the costly and awkward role of collections officer. Due to the risk of fraudulent payment, a TPA may even require that a participant substantiate every card transaction with paper documentation, which then fails to relieve employees and Third-Party Administrators of the traditional challenges associated with participating in and managing a consumer-directed account. Frequent TPA audits and collection activities can significantly undermine the efficiencies that stored value programs were designed to achieve.

Because the IRS has the ability to levy substantial fines for non-compliance, many employers are unwilling to accept the risks associated with current stored value programs, opting instead for the less efficient but potentially more compliant traditional, manual process.

In view of the foregoing, it would be desirable to provide a method and system for electronically substantiating claims prior to payment from consumer-directed accounts which overcome the above-described inadequacies and shortcomings.

### SUMMARY OF THE INVENTION

According to an embodiment of the present invention, a method and system provides for electronically substantiating claims prior to making payments from consumer-directed accounts (e.g., Flexible Spending Accounts, Medical Savings Accounts, Health Reimbursement Arrangements, etc.) and facilitating settlement and messaging throughout a transaction cycle.

According to an exemplary embodiment of the present invention, a computer implemented method for providing consumer-directed account management comprises the steps of: receiving a request for payment for a transaction wherein the request comprises claim data identifying the transaction and a payment amount; adjudicating the request to determine claim eligibility; requesting a validation of available funds in a consumer-directed account associated with a participant for the payment amount, wherein a party contributes a predetermined amount of funds, to the consumer-directed account; receiving a confirmation indicating whether the consumer-directed account contains sufficient funds to cover the payment amount; and transmitting a validation message indicating payment validation and claim eligibility.

In accordance with other aspects of this exemplary embodiment of the present invention, the transaction is related to at least one prescription; the transaction is related to a visit to a healthcare provider; the transaction is related to a purchase from a merchant of healthcare products; the party is the participant; the party is an entity different from the participant; the consumer-directed account comprises a Flexible Spending Account associated with the participant wherein the participant designates a predetermined amount of pre-taxed dollars to be deducted from the participant's paycheck and contributed to the participant's consumer-directed account; the consumer-directed account comprises a Medical Savings Account associated with the participant; the consumer-directed account comprises a Health Reimbursement Arrangement account associated with the participant; the step of adjudicating further comprises the step of determining whether the transaction is for an eligible medical purpose; the method further comprises the step of making a payment in the amount of the payment amount to one of a pharmacy benefit manager and insurer; the method further comprises the step of making a payment in the amount of the payment amount to one of a pharmacy and healthcare provider; the method further comprises the step of making a payment in the amount of the payment amount to a merchant of healthcare products; the method further comprises the step of settling the transaction by forwarding the payment for the transaction from the consumer-directed account; the transaction is a card transaction at a Merchant Provider's point of sale; the confirmation indicates that the payment amount will be deducted from the consumer-directed account; and the payment amount not covered by the consumer-directed account is owed by the participant.

According to another exemplary embodiment of the present invention, a computer implemented system for providing consumer-directed account management comprises: a claim eligibility module for receiving a request for payment for a transaction wherein the request comprises claim data identifying the transaction and a payment amount; and a funds availability module for requesting a validation of available funds in a consumer-directed account associated with a participant for the payment amount, wherein a party contributes a predetermined amount of funds to the consumer-directed account; receiving a confirmation indicating whether the consumer-directed account contains sufficient funds to cover the payment amount and transmitting a validation message indicating payment validation and claim eligibility.

### BRIEF DESCRIPTION OF THE DRAWINGS

In order to facilitate a fuller understanding of the present invention, reference is now made to the appended drawings. These drawings should not be construed as limiting the present invention, but are intended to be exemplary only.

FIG. 1 is an exemplary diagram of a system for managing consumer-directed accounts, according to an embodiment of the present invention.

FIG. 2 is an exemplary flowchart of a method for managing consumer-directed accounts, according to an embodiment of the present invention.

FIG. 3 is another exemplary flowchart of a method for facilitating a card transaction, according to an embodiment of the present invention.

FIG. 4 is another exemplary flowchart of a method for facilitating manual claim submission, according to an embodiment of the present invention.

### DETAILED DESCRIPTION OF EXEMPLARY EMBODIMENT(S)

An embodiment of the present invention is directed to a method and system for electronically substantiating claims prior to payment from consumer-directed accounts, such as Flexible Spending Accounts (FSAs). An embodiment of the present invention may substantiate expenses by using direct links to participants in healthcare and other transactions to receive and adjudicate transaction-level claims information. Electronically substantiating claims prior to payment eliminates or reduces the problems associated with migrating from the current manual processes to stored value programs. Exemplary spending categories may include but are not limited to pharmaceuticals, co-payments (co-pays), dental expenses and eye care services, for example. An embodiment of the present invention may also relate to Health Reimbursement Arrangements (HRAs), Medical Savings Accounts (MSAs), Dependent Care Flexible Spending Accounts, or other consumer-directed accounts, including consumer-directed savings accounts. Another embodiment of the present invention is directed to facilitating settlement and messaging throughout a transaction cycle.

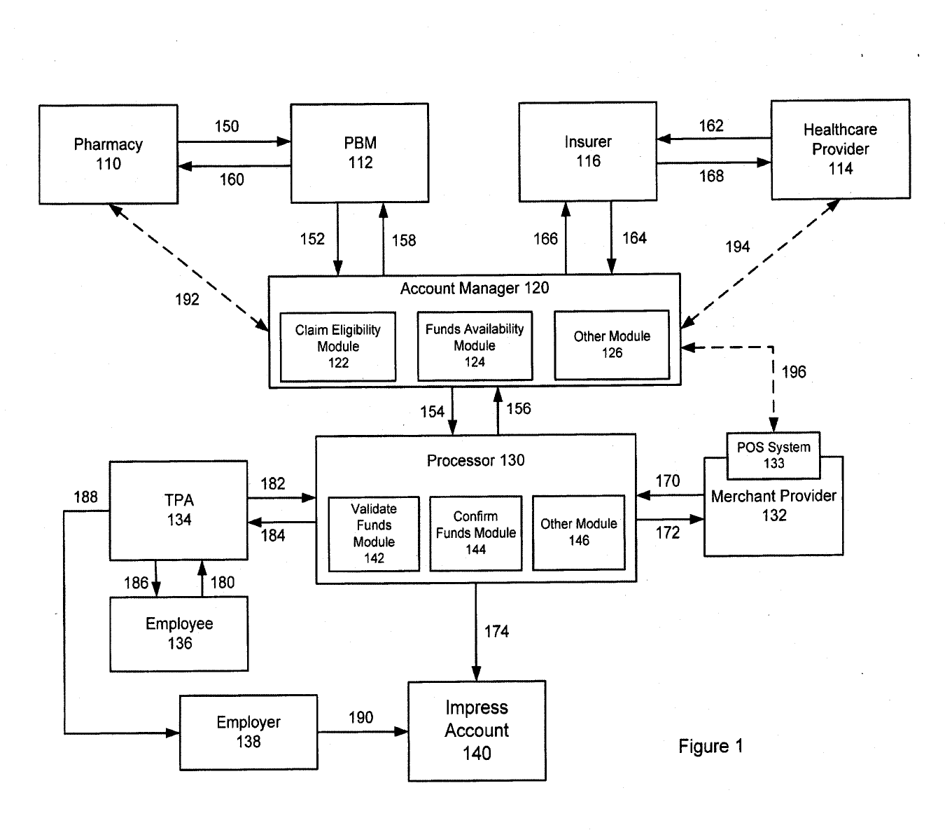

FIG. 1 is an exemplary diagram of a system for managing consumer-directed accounts, according to an embodiment of the present invention. A participant (e.g., employee, etc.) may engage in a transaction for healthcare products and/or services (e.g., prescription drugs) through an entity, such as Pharmacy 110. Pharmacy 110 may be a retail store, a mail order facility, a physician affiliated store or other entity providing products and/or services. In response to the participant's request for one or more products and/or services, Pharmacy 110 may transmit claim data to a Pharmacy Benefit Manager (PBM) 112, as shown by 150. This transmission may be in electronic, paper, or other format. In accordance with various embodiments of the present invention, communication may be established via Internet, Ethernet, Intranet, wireless communication and/or other modes of electronic communication or other form of communication. Claim data may include information associated with the one or more products and/or services requested by the participant. For example, claim data may include participant name, social security number (or other identifier), insurance provider data, prescription code data, payment amount due data, transaction data and/or other information.

PBM 112 may manage claims from one or more pharmacies and perform claim adjudication. For example, Pharmacy 110 may verify claim or prescription eligibility and determine a participant co-pay amount through PBM 112. More specifically, PBM 112 may adjudicate the claim, which may involve determining whether the transaction is covered by insurance (or other entity) and the amount owed by the participant (e.g., the self-pay due). PBM 112 may transmit claim data with self-pay due information to Account Manager 120, as shown by 152. Self-pay due may represent the remaining balance due or the amount due by the participant. For example, a participant may purchase a prescription drug from Pharmacy 110. Based at least in part on information provided by Pharmacy 110, PBM 112 may determine that the prescription drug will cost $100, where $80 will be covered by insurance and the participant will be liable for $20 (e.g., the self-pay due). Thus, PBM 112 may determine the amount owed by the participant and payable by the participant's account (e.g., FSA, MSA, HRA or other consumer-directed account), if funds are available and if the claim is eligible for payment.

PBM 112 may implement an internal process for determining which transmissions (e.g., claim data with self-pay due information) are to be sent to Account Manager 120. In addition, PBM 112 may also determine a preferred method of communication with Account Manager 120. According to another example, PBM 112 may receive a list of participants (or other identifiers) from Account Manager 120 (or other source) indicating which transmissions are to be forwarded to Account Manager 120 for further processing, including claim eligibility determination, funds availability determination and other determinations.

Account Manager 120 may adjudicate the claim, which may involve substantiation of the claim based on eligibility requirements (e.g., FSA or other requirements). Account Manager 120 may provide management functionality associated with consumer-directed accounts. For example, Account Manager 120 may include functionality associated with claim eligibility determination, funds availability determination and other determinations. More specifically, Account Manager 120 may determine whether the claim is eligible for FSA (or other) payment (e.g., whether the transaction is for a valid medical purpose) and whether the account (e.g., FSA, MSA, HRA or other consumer-directed account) associated with the participant has available funds to cover the self-pay due. In addition, other determinations may be performed by Account Manager 120.

Claim eligibility module 122 may determine whether the transaction qualifies for payment. For example, FSA (or other) payment may be restricted for certain types of transactions. For example, if the claim is associated with valid prescription drugs, such as antibiotics for an illness or other infection, the claim may be considered a valid medical expense. However, if the claim is for cosmetic purposes or other enhancements, such as certain anti-aging products, the claim may not be eligible for payment s from the consumer-directed account. Account Manager 120 may adjudicate individual expenses against established guidelines (e.g., IRS guidelines) to determine eligibility. In addition, Account Manager 120 may provide a mechanism for FSA (or other) sponsors, such as employers or Third Party Administrators, to add additional eligibility restrictions based on specific requirements of a particular FSA (or other consumer directed account) program. In addition, other restrictions may be applied in determining claim eligibility.

Once claim eligibility is determined, Funds Availability Module 124 may determine whether the participant's account (e.g., consumer-directed account) has sufficient funds to cover the self-pay due. Account Manager 120 may send an authorization request to Processor 130 to validate the available funds in the participant's account (e.g., consumer-directed account), as shown by 154. PBM 112, Account Manager 120 and/or Processor 130 may or may not be the same entity. For example, Account Manager 120 and Processor 130 may be separately operated, associated with each other or operated by the same entity. Other arrangements and/or associations may be implemented. The authorization request may be received by Validate Funds Module 142. If funds are available, Confirm Funds Module 144 may send a confirmation to Account Manager 120 indicating that sufficient funds are available in the participant's account (e.g., consumer-directed account), as shown by 156. If funds are unavailable, Confirm Funds Module 144 may send a message to Account Manager 120 indicating that the participant is unable to finance the purchase through the participant's account (e.g., consumer-directed account), and may therefore remit a different form of payment to Pharmacy 110. In addition, the consumer-directed account may have funds to cover a portion of the self-pay due amount. In this case, Confirm Funds Module 144 may send a message to Account Manager 120 indicating that a portion of the self-pay due may be payable through the participant's account (e.g., consumer-directed account) with the remaining amount due by the participant. Other functionality may be provided as shown by Other Modules 126 and 146.

Once claim eligibility and funds availability are determined, Account Manager 120 may send a validation message to PBM 112 indicating status of claim eligibility and availability of consumer-directed account funds, as shown by 158. In response, PBM 112 may send a claim response to Pharmacy 110 with data related to an amount payable by insurance, PBM or other entity, amount payable by consumer-directed account and self-pay due, if any, as shown by 160. This response may be in electronic, paper, or other format. For example, the claim response may indicate that insurance will cover $80 of the prescription and $20 has been paid from the consumer-directed account. As such, the participant does not need to remit payment to Pharmacy 110. In another example, if the consumer-directed account does not have sufficient funds to cover the participant's portion of the prescription cost, the participant will have to pay the remaining balance. For example, the claim response may indicate that insurance will cover $80 of the prescription, the participant's account (e.g., FSA, MSA, HRA or other consumer-directed account) will cover $10 and the participant will be responsible for the remaining $10.

The participant may then receive the requested services and/or products from Pharmacy 110. An embodiment of the present invention provides real time or batch claim substantiation to validate that a claim is for a valid purpose and remits the payment due by the participant from the consumer-directed account, if funds are available. Therefore, granted the participant has available funds in the consumer-directed account, the participant incurs no out of pocket costs and manual claim submission is unnecessary. Moreover, because authorization may be based on specific transaction-level data, there is no or minimal risk of non-compliance with guidelines (e.g., IRS guidelines) for the types of purchases that may be made through a consumer-directed account.

To finalize the settlement, Account Manager 120 may make a payment to PBM 112 for the amount payable by the participant's account (e.g., FSA, MSA, HRA or other consumer-directed account). In response, PBM 112 may make a payment to Pharmacy 110 for the amount payable by the consumer-directed account. In another example, PBM 112 may make a payment to Pharmacy 110 and receive subsequent payment from Account Manager 120. Other payment arrangements and sequences may be implemented. Payment from Account Manager 120 to PBM 112 may be made through an impress or other account.

According to another example, Pharmacy 110 may communicate directly with Account Manager 120, as shown by 192. In this example, Pharmacy 110 may transmit claim data with prescription drug identifiers as well as other information to Account Manager 120. Account Manager 120 may then substantiate the claim and debit the participant's account (e.g., FSA, MSA, HRA or other consumer-directed account) accordingly, as discussed above.

In another example, a participant (e.g., employee, etc.) may receive services and/or products from a Healthcare Provider 114. For example, a participant may visit a doctor or hospital (or other healthcare provider) to receive treatment, advice or other services and/or products. Healthcare Provider 114 may include a physician, hospital, specialist, psychologist, physical therapist, optometrist, dentist or other provider. In response to the participant's visit, Healthcare Provider 114 may transmit claim data to an Insurer 116, as shown by 162. This transmission may be in electronic, paper, or other format. In accordance with various embodiments of the present invention, communication may be established via Internet, Ethernet, Intranet, wireless communication and/or other modes of electronic communication or other form of communication. Claim data may include information associated with the visit, such as treatment type and other services performed by the healthcare provider. For example, claim data may include participant name, social security number (or other identifier), insurance provider data, payment amount due data, transaction data and/or other information.

Insurer 116 may manage claims from one or more healthcare providers and perform claim adjudication. For example, Healthcare Provider 114 may verify insurance eligibility and determine a participant co-pay amount through Insurer 116. More specifically, Insurer 116 may adjudicate the claim, which may involve determining whether the transaction is covered by insurance (or other entity) and the amount owed by the participant (e.g., the self-pay due). Insurer 116 may transmit claim data with self-pay due information to Account Manager 120, as shown by 164. Self-pay due may represent the remaining balance due or the amount due by the participant. For example, a participant may visit a doctor to receive treatment or other services (e.g., x-rays, blood tests, etc.) from Healthcare Provider 114. Based at least in part on information provided by Healthcare Provider 114, Insurer 116 may determine that the treatment will cost $100, where $80 will be covered by insurance and the participant will be liable for $20 (e.g., the self-pay due). Thus, Insurer 116 may determine the amount owed by the participant and payable by the participant's account (e.g., FSA, MSA, HRA or other consumer-directed account), if funds are available and if the claim is eligible for payment.

Insurer 116 may implement an internal process for determining which transmissions (e.g., claim data with self-pay due information) are to be sent to Account Manager 120. In addition, Insurer 116 may also determine a preferred method of communication with Account Manager 120. According to another example, Insurer 116 may receive a list of participants (or other identifiers) from Account Manager 120 (or other source) indicating which transmissions are to be forwarded to Account Manager 120 for further processing, including claim eligibility determination, funds availability determination and other determinations.

Account Manager 120 may adjudicate the claim, which may involve substantiation of the claim based on eligibility requirements (e.g., FSA or other requirements). Account Manager 120 may provide management functionality associated with consumer-directed accounts. For example, Account Manager 120 may include functionality associated with claim eligibility determination, funds availability determination and other determinations. More specifically, Account Manager 120 may determine whether the claim is eligible for FSA (or other) payment (e.g., whether the transaction is for a valid medical purpose) and whether the account (e.g., FSA, MSA, HRA or other consumer-directed account) associated with the participant has available funds to cover the self-pay due. In addition, other determinations may be performed by Account Manager 120.

Claim eligibility module 122 may determine whether the transaction qualifies for payment. For example, FSA (or other) payment may be restricted for certain types of transactions. For example, if the claim is associated with a medical visit, such as a check-up or other treatment, the claim may be considered a valid medical purpose. However, if the claim is for cosmetic purposes, such as teeth whitening or anti-aging treatments, the claim may not be eligible for payment from the consumer-directed account. Account Manager 120 may adjudicate individual expenses against established guidelines (e.g., IRS guidelines) to determine eligibility. In addition, Account Manager 120 may provide a mechanism for FSA (or other) sponsors, such as employers or Third Party Administrators, to add additional eligibility restrictions based on specific requirements of a particular FSA (or other consumer-directed account) program. In addition, other restrictions may be applied in determining claim eligibility.

Once claim eligibility is determined, Funds Availability Module 124 may determine whether the participant's consumer-directed account has sufficient funds to cover the self-pay due. Account Manager 120 may send an authorization request to Processor 130 to validate the available funds in the participant's consumer-directed account, as shown by 154. Insurer 116, Account Manager 120 and/or Processor 130 may or may not be the same entity. For example, Account Manager 120 and Processor 130 may be separately operated, associated with each other or operated by the same entity. Other arrangements and/or associations may be implemented. The authorization request may be received by Validate Funds Module 142. If funds are available, Confirm Funds Module 144 may send a confirmation to Account Manager 120 indicating that sufficient funds are available in the participant's account (e.g., consumer-directed account), as shown by 156. If funds are unavailable, Confirm Funds Module 144 may send a message to Account Manager 120 indicating that the participant is unable to finance the purchase through the participant's account (e.g., consumer-directed account) and may therefore remit a different form of payment to Healthcare Provider 114. In addition, the consumer-directed account may have funds to cover a portion of the self-pay due amount. In this case, Confirm Funds Module 144 may send a message to Account Manager 120 indicating that a portion of the self-pay due may be payable through the participant's consumer-directed account with the remaining amount due by the participant. Other functionality may be provided as shown by Other Modules 126 and 146.

Once claim eligibility and funds availability are determined, Account Manager 120 may send a validation message to Insurer 116 indicating status of claim eligibility and availability of consumer-directed account funds, as shown by 166. Insurer 116, Account Manager 120 and/or Processor 130 may or may not be the same entity. For example, for HRA, Insurer 116 and Account Manager 120 may be operated by the same entity. Other combinations may be implemented. In response, Insurer 116 may send a claim response to Healthcare Provider 114 with data related to an amount payable by insurance or other entity, amount payable by consumer-directed account and self-pay due, if any, as shown by 168. This response may be in electronic, paper, or other format. For example, the claim response may indicate that insurance will cover $80 of the treatment and $20 has been paid from the participant's account (e.g., consumer-directed account). As such, the participant does not need to remit payment to Healthcare Provider 114 directly. In another example, if the participant's account (e.g., consumer-directed account) does not have sufficient funds to cover the participant's portion of the cost, the participant will have to pay the remaining balance. For example, the claim response may indicate that insurance will cover $80 of the treatment, the participant's account (e.g., FSA, MSA, HRA or other consumer-directed account) will cover $10 and the participant will be responsible for the remaining $10.

An embodiment of the present invention provides real time or batch claim substantiation to validate that a claim is for a valid purpose and remits the payment due by the participant from the consumer-directed account, if funds are available. Therefore, granted the participant has available funds in the consumer-directed account, the participant incurs no out of pocket costs and manual claim submission is unnecessary. Moreover, because authorization may be based on specific transaction-level data, there is no or minimal risk of non-compliance with guidelines (e.g., IRS guidelines) for the types of purchases that may be made through a consumer-directed account.

To finalize the settlement, Account Manager 120 may make a payment to Insurer 116 for the amount payable by the participant account (e.g., FSA, MSA, HRA or other consumer-directed account). In response, Insurer 116 may make a payment to Healthcare Provider 114 for the amount payable by the participant FSA account. In another example, Insurer 116 may make a payment to Healthcare Provider 114 and receive subsequent payment from Account Manager 120. Other payment arrangements and sequences may be implemented. Payment may be made through an impress or other account.

According to another example, Healthcare Provider 114 may communicate directly with Account Manager 120, as shown by 194. In this example, Healthcare Provider 114 may transmit claim data with treatment codes or identifiers, payment amount, as well as other information to Account Manager 120. Account Manager 120 may then substantiate the claim and debit the participant's account (e.g., FSA, MSA, HRA or other consumer-directed account) accordingly, as discussed above.

In accordance with an embodiment of the present invention, Pharmacy 110 and Healthcare Provider 114 may represent any entity providing services and/or products to a participant. In addition, PBM 112, Insurer 116, Account Manager 120, Processor 130 and/or TPA 134 may operate in various combinations or separately. Further, various connections may also be implemented. For example, TPA 134 may establish a direct (or other) connectivity program between TPA 134 and PBM 112 and/or Insurer 116. Other variations may be implemented.

An embodiment of the present invention may also support other transaction environments. For example, a participant may purchase one or more products and/or services through Merchant Provider 132. Merchant Provider 132 may include any retail store, website, telephone contact or other point of sale. The participant may engage in a transaction using a card (or other identifier). In addition, the participant may purchase the one or more products and/or services via the Internet, phone order or other point of sale by providing an identifier (e.g., account number, password, PIN, etc.) associated with a participant's account (e.g., FSA, MSA, HRA or other consumer-directed account). Merchant Provider 132 may send an authorization/payment request to Processor 130, as shown by 170, in response to a card swipe at a Point of Sale terminal, for example, or other transaction (e.g., Internet, phone order, or other point of sale transaction), which may or may not involve an actual card. In response, Processor 130 may send a confirmation to Merchant Provider 132 indicating that the transaction is or is not approved. Processor 130 may request a debit from an employer impress account 140 associated with the participant for the card transaction amount. Impress Account 140 may be a reserve account providing an aggregate representation of a plurality of participants participating in the FSA (or other consumer-directed account) program for a particular employer (or other entity). A fraction of the impress account may be set aside to cover a particular participant's FSA (or other consumer-directed account) plan. Impress Account 140 may be replenished periodically, when the balance is below a predetermined amount or based on other criteria. The PBM and/or Insurer payments discussed above may be made from Impress Account 140 or other account, such as a fully funded account, partially funded account, etc.

According to another example, Account Manager 120 may communicate directly with Merchant Provider 132, as shown by 196. For example, Merchant Provider 132 may support a Point of Sale (POS) System 133 for communication with Account Manager 120. POS System 133 may represent any electronic system used by a merchant (or other entity) to manage and track the sale of products and/or services, such as an accounting system, an inventory management system or other system. In this example, Merchant Provider 132 may send claim data to Account Manager 120 through POS System 133. Account Manager 120 may substantiate the claim and debit the participant's account (e.g., FSA, MSA, HRA or other consumer-directed account), if the claim is eligible and if funds are available. POS System 133 may be separate from or part of Merchant Provider 132.

An embodiment of the present invention may also support manual claim submissions. Employee 136 (or other participant) may manually submit one or more paper claims to a Third Party Administrator (TPA) 134 for reimbursement of expenses, such as healthcare expenses (or other transactions) from a participant's account (e.g., FSA, MSA, HRA or other consumer-directed account), as shown by 180. TPA 134 may determine or confirm whether the claims are eligible for reimbursement (or other payment). TPA 134 may send a claim batch which may include transfer of data to Processor 130 for claim approval, via 182. The claim batch may include a plurality of claim data for one or more participants received by TPA 134 during a predetermined time (e.g., a number of hours, a day, etc.). Processor 130 may determine whether sufficient funds are available. In response, Processor 130 may provide a confirmation to TPA 134 that sufficient funds are available or unavailable in a participant's account (e.g., FSA, MSA, HRA or other consumer-directed account), via 184. If funds are available for full or partial reimbursement, TPA 134 may then forward a payment to employee 136 (or other participant) for an approved reimbursement, as shown by 186.

In addition, Processor 130 may also generate a data report which may include account balance data, claim status and/or other information. The data report may be generated and transmitted to TPA 134 daily or at other time intervals. TPA 134 may also transmit a funding request to Employer 138, as shown by 188, which may include a request to replenish Impress Account 140. The funding request may be based on various factors, such as a disbursement exceeding a threshold amount and/or other triggers. In response, Employer 138 may replenish Impress Account 140 for a predetermined or variable amount, as shown by 190. For example, if the consumer-directed account is fully funded and does not draw on a partially-funded Impress Account, TPA 134 may not be required to submit a funding request to Employer 138.

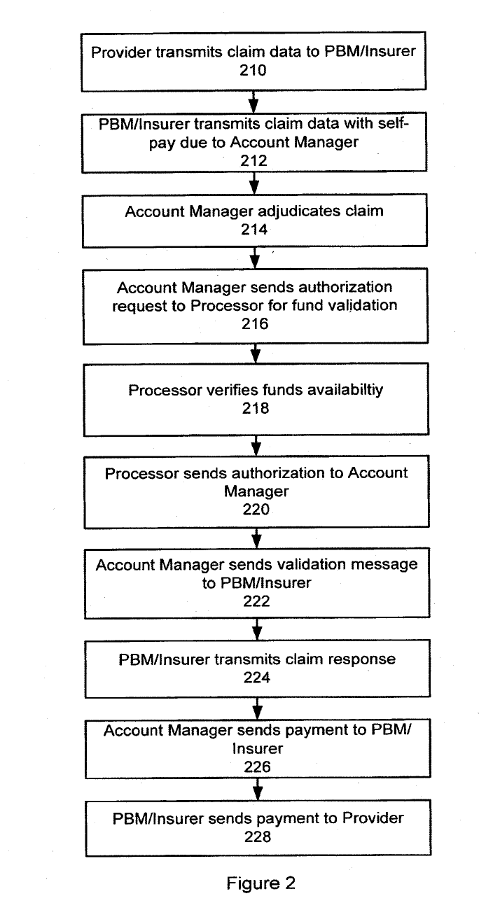

FIG. 2 is an exemplary flowchart of a method for managing consumer-directed accounts, according to an embodiment of the present invention. At step 210, a provider may transmit claim data to PBM, Insurer or other entity. At step 212, the PBM, Insurer or other entity may transmit claim data with a self-pay due to an Account Manager. The Account Manager may provide management functionality for consumer-directed accounts, such as FSA, MSA, HRA, etc. At step 214, the Account Manager may adjudicate the claim, which may involve determining claim eligibility and funds availability. At step 216, Account Manager may send an authorization request to the Processor for funds availability validation. At step 218, the Processor may verify funds availability. At step 220, the Processor may send a confirmation to Account Manager in response. Based on the funds available in the participant's account (e.g., FSA, MSA, HRA or other consumer-directed account), the confirmation may indicate that funds are available, unavailable or partially available. At step 222, Account Manager may send a validation message to the PBM, Insurer or other entity. At step 224, the PBM, Insurer or other entity may transmit a claim response to the provider who initiated the transaction. At step 226, the Account Manager may send a payment to the PBM, Insurer or other entity. At step 228, the PBM, Insurer or other entity may send the payment to the Provider. In another example, step 228 may occur before step 226. Other variations in sequence may be implemented.

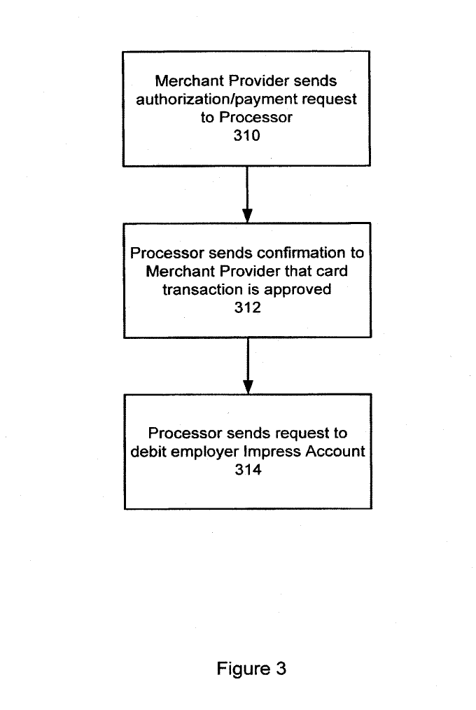

FIG. 3 is another exemplary flowchart of a method for facilitating a card transaction, according to an embodiment of the present invention. In connection with the functionality associated with the Account Manager, card transaction functionality may also be provided by an embodiment of the present invention. At step 310, a Merchant Provider may send an authorization or payment request to a Processor. At step 312, the Processor may send a confirmation to the Merchant Provider that the card transaction has been approved. At step 314, the Processor may send a request to debit an employer Impress Account. Settlement may take place through an Impress Account or other account.

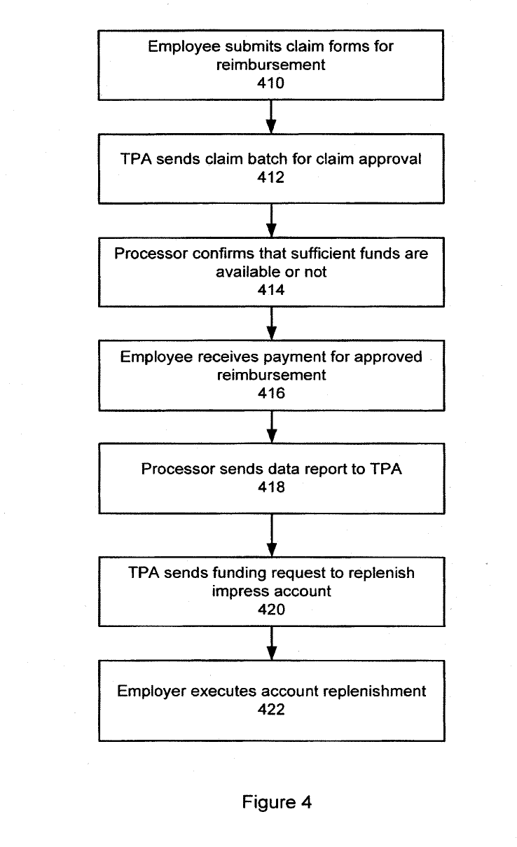

FIG. 4 is another exemplary flowchart of a method for facilitating manual claim submission, according to an embodiment of the present invention. In connection with the functionality associated with the Account Manager, manual claim submission functionality may also be provided by an embodiment of the present invention. At step 410, a participant (e.g., employee) may submit one or more claim forms for reimbursement to a TPA. In addition, the TPA may determine claim eligibility. At step 412, a TPA may send a claim batch for claim approval to a Processor. At step 414, the Processor may confirm that sufficient funds are available or not. At step 416, the participant may receive payment for approved reimbursement. At step 418, the Processor may send a data report to the TPA. At step 420, the TPA may send a funding request to replenish an impress account. At step 422, the employer may execute the account replenishment.

The present invention is not to be limited in scope by the specific embodiments described herein. Indeed, various modifications of the present invention, in addition to those described herein, will be apparent to those of ordinary skill in the art from the foregoing description and accompanying drawings. Thus, such modifications are intended to fall within the scope of the following appended claims. Further, although the present invention has been described herein in the context of a particular implementation in a particular environment for a particular purpose, those of ordinary skill in the art will recognize that its usefulness is not limited thereto and that the present invention can be beneficially implemented in any number of environments for any number of purposes. Accordingly, the claims set forth below should be construed in view of the full breath and spirit of the present invention as disclosed herein.

1-34. (canceled)

35. A computer implemented method for providing consumer-directed account management, the computer implemented method comprising the steps of:
an interface at an account manager receiving a first electronic message comprising a request for payment from a healthcare provider for a transaction, the request comprising claim data identifying a type of transaction and a payment amount;
a computer processor at the account manager adjudicating the request and determining that the type of transaction is for a valid medical purpose;
the computer processor at the account manager communicating a second electronic message to a payment processor comprising a request for confirmation that a consumer-directed account contains sufficient funds to cover the payment amount from a payment processor;
the computer processor at the account manager receiving a third electronic message from the payment processor comprising confirmation that the consumer-directed account contains sufficient funds; and
the computer processor at the account manager settling the transaction by electronically sending a payment for the payment amount from the consumer-directed account to the healthcare provider.

36. The method of claim 35, wherein the healthcare provider is one of a pharmacy and a merchant of healthcare products.

37. The method of claim 35, wherein the type of transaction comprises a drug transaction.

38. The method of claim 35, wherein the type of transaction comprises a medical procedure transaction.

39. The method of claim 35, wherein the type of transaction comprises a medical device transaction.

40. The method of claim 35, wherein the consumer-directed account is one of a FSA account, a MSA account, and an HRA account.
